(19) United States
(12) Patent Application Publication
(10) Pub. No.: US 2026/0292066 A1
(43) Pub. Date: Sep. 24, 2026

(54) DISPLAY OF SESSION CAPTIONS ON AN ENDPOINT USING OFF-ENDPOINT CAPTION GENERATION

(71) Applicant: Avaya Management L.P., Morristown, NJ (US)

(72) Inventors: Paul Roller Michaelis, Louisville, CO (US); Paul Haig, Carrying Place (CA)

(21) Appl. No.: 19/083,658

(22) Filed: Mar. 19, 2025

(51) Int. Cl. H04M 3/42; G06F 40/58; G10L 15/26

(52) U.S. Cl. CPC H04M 3/42391; G06F 40/58; G10L 15/26; H04M 2201/40

(57) ABSTRACT

The technology disclosed herein enables captioning for a communication session on a display of an endpoint using an adjunct device to generate captions. In a particular example, a method includes receiving, at a first endpoint of the communication session, audio from a second endpoint of the communication session. The method further includes passing the audio in real time to an adjunct device of the first endpoint over a local connection and performing, in the adjunct device, real-time speech-to-text processing on the audio to generate captions of speech identified in the audio. The method also includes transmitting the captions in real time to the first endpoint over the local connection and displaying the captions in real-time on a display of the first endpoint.

### BACKGROUND

Many high-end mobile smartphones offer streaming text captions for spoken words during communication sessions, primarily to support users with hearing loss. This speech-to-text conversion happens within the device itself. However, very few desktop telephones support in-device caption creation because, unlike multi-function smartphones, desktop telephones are solely used for voice communication. Consequently, they rarely have enough computational power to handle speech-to-text processing.

In the United States, desktop telephone users with hearing loss can access captioning services where the speech-to-text conversion occurs in a central location called a relay center. The captions are then transmitted to the user’s telephone using special mechanisms, sometimes via the Internet, and in some cases, using the SIP RFC-4103 and/or RFC-5194 real-time text protocols. Some residential phones may similarly rely on a proprietary modem protocol that combines voice and text within a single stream. In all the above implementations, the user needs to initiate a three-party conference call between the user requiring captions, the far-end party, and the relay service.

### SUMMARY

The technology disclosed herein enables captioning for a communication session on a display of an endpoint using an adjunct device to generate captions. In a particular example, a method includes receiving, at a first endpoint of the communication session, audio from a second endpoint of the communication session. The method further includes passing the audio in real time to an adjunct device of the first endpoint over a local connection and performing, in the adjunct device, real-time speech-to-text processing on the audio to generate captions of speech identified in the audio. The method also includes transmitting the captions in real time to the first endpoint over the local connection and displaying the captions in real-time on a display of the first endpoint.

In another example, an apparatus is provided to implement an adjunct device. The apparatus includes one or more computer readable storage media, and a processing system operatively coupled with the one or more computer readable storage media. Program instructions stored on the one or more computer readable storage media, when read and executed by the processing system, direct the apparatus to receive, over a local connection, communication signaling in real time from a first endpoint of the communication session. The first endpoint received the communication signaling from a second endpoint over the communication session. The program instructions further direct the apparatus to perform real-time processing on the communication signaling to generate captions of words identified in the communication signaling and transmit the captions in real time to the first endpoint over the local connection. The first endpoint presents the captions to a user of the first endpoint in real time.

A further example provides an apparatus implementing an endpoint. The apparatus includes a display, one or more computer readable storage media, and a processing system operatively coupled with the one or more computer readable storage media. Program instructions stored on the one or more computer readable storage media, when read and executed by the processing system, direct the apparatus to receive user communications over the communication session from an endpoint on the communication session and transmit the user communications in real time to an adjunct device via a channel separate from the communication session. The program instructions also direct the apparatus to receive, from the adjunct device via the channel, real time captions generated by the adjunct device from the user communications and display the real time captions in real time on the display.

### BRIEF DESCRIPTION OF THE DRAWINGS

FIG. 1 illustrates an implementation for an adjunct device to caption a communication session on an endpoint.

FIG. 2 illustrates an operation to caption a communication session on an endpoint using an adjunct device.

FIG. 3 illustrates an operational scenario for captioning a communication session on an endpoint using an adjunct device.

FIG. 4 illustrates an operation to caption a communication session on an endpoint using an adjunct device.

FIG. 5 illustrates an implementation for an adjunct device to caption a communication session on an endpoint.

FIG. 6 illustrates an operation to caption a communication session on an endpoint using an adjunct device.

FIG. 7 illustrates an operation to caption a communication session on an endpoint using an adjunct device.

FIG. 8 illustrates an endpoint device to caption a communication session thereon using an adjunct device.

FIG. 9 illustrates an adjunct device to generate captions for a communication session on an endpoint.

FIG. 10 illustrates a computing system for captioning a communication session on an endpoint using an adjunct device.

### DETAILED DESCRIPTION

The endpoint devices (e.g., desktop telephones) of the examples herein execute software and/or firmware enabling them to send received session communications (e.g., a voice signal) to an external resource, referred to herein as an adjunct device. The endpoint devices receive text back from the external resource and display the received text to caption the session communications. The captions may be especially beneficial for hard-of-hearing users.

A Universal Serial Bus (USB) port on an endpoint device may be used to connect the endpoint and the adjunct device. Other local connection types, such as Bluetooth or a Local Area Network (LAN), may be used in other examples to provide a channel between the endpoint and the adjunct device. The endpoint may extract the audio signal from communication packets received from one or more other endpoints and streams the audio signal to the adjunct device. The adjunct device processes the audio stream using real-time speech-to-text methods and creates a corresponding text stream. The text stream is sent back to the endpoint of the channel therewith and displayed on the endpoint’s display.

The adjunct device may be portable, potentially enabling hearing-impaired users to bring the adjunct device with them to use on any compatible endpoint device, allowing captioning on multiple phones. In another example, an endpoint may connect to a user’s co-located Personal Computer (PC), which may require only software to function as the adjunct device. The communication link between the endpoint and the PC may be a LAN to which both devices are connected. The adjunct device may also create and save session transcripts, allowing users to select whether to see captions for received speech only or for both received and transmitted speech therein (or even during real-time captioning). Even when audio output from the endpoint is disabled (e.g., muted), captioning of the received voice may still be supported. Inputs to the speech-to-text adjunct may include decoded digital audio or a Real-time Transport Protocol (RTP) stream rather than the disabled output of the endpoint.

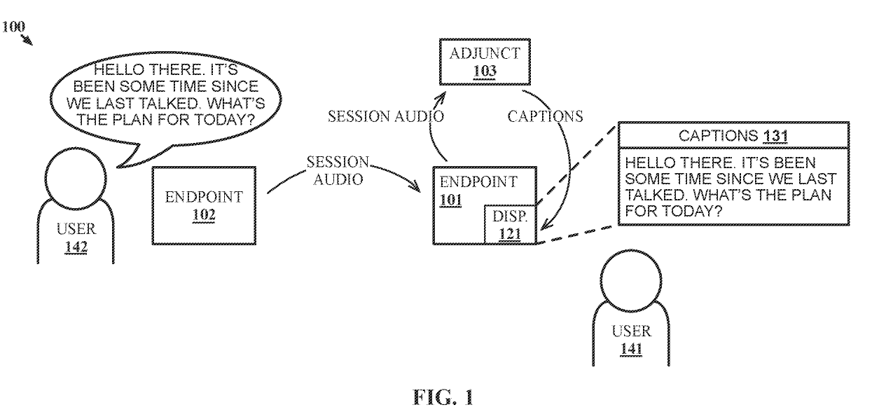

FIG. 1 illustrates implementation 100 for an adjunct device to caption a communication session on an endpoint. Implementation 100 includes endpoint 101, endpoint 102, and adjunct device 103. Although not shown, endpoint 101 and endpoint 102 communicate over one or more wired and/or wireless communication links. The communication links may be direct links or may include intervening systems, networks, and/or devices. Likewise, endpoint 101 and endpoint 102 may communicate through a communication session system (e.g., communication server) that facilitates exchange of user communications between endpoints. Endpoint 101 and endpoint 102 may each respectively be a telephone, tablet computer, laptop computer, desktop computer, conference room system, or some other type of computing device capable of establishing real-time user communication sessions for their respective users 141-142. In some examples, one or both of endpoints 101-102 may connect to the Public Switched Telephone Network (PSTN).

Adjunct device 103 is connected to endpoint 101 using a communication link for connecting with nearby devices. For example, USB is a common wired connection between nearby devices and Bluetooth is a common wireless connection between nearby devices, as both connection mechanisms have a limited amount of distance they can support (e.g., a USB cable can only be so long while still maintaining signal and Bluetooth radios can only communicate so far before the signal attenuates too much to work). Links to a shared LAN may also be used, such as Ethernet or WIFI links. While such links often also allow devices to communicate between locations (e.g., over the Internet), endpoint 101 and adjunct device 103 are collocated such that user 141 is within physical control of both devices rather than relying on a third party administration. Adjunct device 103 includes hardware and software enabling adjunct device 103 to perform speech-to-text processing in real time. Adjunct device 103 performs the processing on communications received by endpoint 101 over a communication session rather than connecting to the communication session as an endpoint itself, as adjunct device 103 may not be equipped with hardware necessary to connect to communication session. This enables adjunct device 103 to be a relatively inexpensive component relative to an endpoint device being produced to include speech-to-text processing capabilities.

Endpoint 101 is configured to transmit at least communications received over the communication session to adjunct device 103 so adjunct device 103 can generate captions in real time for presentation to user 141 via display 121. Although, communications captured from user 141 (e.g., via a headset or built-in microphone) may also be passed to adjunct device 103 for processing in some cases. Endpoint 101 may pass the communications to adjunct device 103 for processing because endpoint 101 is not capable of generating the captions on its own, adjunct device 103 may do a better job of generating captions than endpoint 101 can do on its own, or for some other reason it is not possible, or desirable, for endpoint 101 to generate the captions on its own. Even if endpoint 101 is not generating captions, endpoint 101 includes display 121. Display 121 may be used to show caller identification, contact information, device settings, or some other type of information relevant to the operation of endpoint 101. As such, display 121 may be a relatively simplistic (e.g., inexpensive) display that does not need to display more than text characters and numbers. Although, some examples may use more advanced displays, such as full color Liquid Crystal Displays (LCDs). Regardless, display 121 is used to display text generated by adjunct device 103 to caption communications received by endpoint 101. Since display 121 is already configured to display text and adjunct device 103 is performing the processing to generate the caption text, endpoint 101 is given additional functionality (i.e., captioning functionality) without needing built-in hardware supporting that functionality.

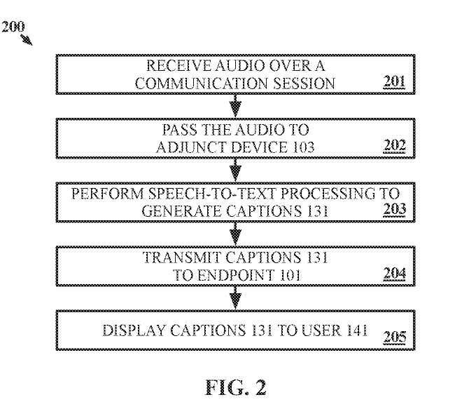

FIG. 2 illustrates operation 200 to caption a communication session on an endpoint using an adjunct device. In operation 200, endpoint 101 and endpoint 102 are endpoints to a real-time communication session enabling user 141 and user 142 to speak with one another. The communication session may be a voice call, a conference call, or some other type of session enabling user 142 to speak with user 141. Endpoint 101 receives audio from endpoint 102 over the communication session (step 201). Endpoint 102 captured the audio, which includes words spoken by user 142. The audio may be sent using an analog signal (e.g., over the PSTN) or may be digitized. A digital audio signal may be encrypted and formatted for transmission to endpoint 101. In some examples, more than two endpoints may be on the communication session and the audio from endpoint 102 may be transmitted to other endpoints in addition to endpoint 101.

Endpoint 101 passes the received audio in real time to adjunct device 103 over a local connection (step 202). The real-time nature of the audio being passed to adjunct device 103 means as the audio stream is received from endpoint 102, endpoint 101 streams the audio to adjunct device 103 to ensure the audio can be captioned as quickly as possible. The audio is passed to adjunct device 103 without endpoint 101 modifying the audio in a manner that would affect the ability of adjunct device 103 to perform speech-to-text processing on speech from user 142 therein. Depending on the format of the audio when received from endpoint 102, endpoint 101 may reformat the audio into a format supported by adjunct device 103. For instance, endpoint 101 may decrypt packets carrying the audio from endpoint 102 and may send the audio to adjunct device 103 as unencrypted RTP packets. The local connection is a relatively low latency connection between collocated devices adjunct device 103 and endpoint 101 to ensure captions can be displayed as quickly as possible. The local connection may be USB, Bluetooth, LAN, Thunderbolt, or some other connection capable of carrying audio and text communications.

Adjunct device 103 performs real-time speech-to-text processing on the audio to generate captions 131 of speech identified in the audio (step 203). Any speech-to-text algorithm may be used by adjunct device 103. Adjunct device 103 may include processing circuitry tailored to a specific type of algorithm or may be more generic circuitry. Adjunct device 103 transmits the captions in real time to endpoint 101 over the local connection (step 204). As such, whenever the processing identifies a next word in the sequence of words in the audio, adjunct device 103 sends the text of the word to endpoint 101. The text of identified words is streamed from adjunct device 103 to endpoint 101.

Upon receiving captions 131 from adjunct device 103, endpoint 101 displays endpoint 101 in real-time on display 121 (step 205). As noted above, when a word is identified from the audio, the word is sent to endpoint 101. Endpoint 101 displays the received word as soon as the word is received. The real-time nature the steps in operation 200 ensures words are displayed in captions 131 as close in time as possible to the words being spoken in the audio presented by endpoint 101. Using the example sentences in implementation 100, when endpoint 101 receives audio of the word “Hello” that audio is immediately passed to adjunct device 103 where adjunct device 103 identifies the text of the word “Hello.” The text is sent back to endpoint 101 for display on display 121. As such, user 141 is presented with “Hello” on display 121 before user 142 has even finished speaking the sentences. Likewise, if endpoint 101 is playing the received audio through a speaker to user 141, user 141 should see “Hello” displayed at the same time, or very shortly after (e.g., due to latency), user 141 hears “Hello” in the playback. The remaining words would then be displayed on display 121 as they are determined by adjunct device 103 near in time to their playback to user 141. In some examples, adjunct device 103 may anticipate a next word for the captions based on the words previously identified. For instance, a machine learning algorithm may be trained on previous conversations, or other language training material, to determine a likely sequence of words. This anticipation may allow adjunct device 103 to provide captions with even lower latency. If an anticipated word ends up being incorrect, then adjunct device 103 may replace the anticipated word with a correct word identified using the speech-to-text processing. Similarly, some words may sound alike, especially those that are homophones of each other (e.g., their, there, and they’re). To account for like sounding words, adjunct device 103 may also autocorrect an identified word to another like-sounding word when the other word is more appropriate in context.

While this example only includes two endpoints on a communication session, other examples may include more than two endpoints. Operation 200 may be performed with audio received from all endpoints or from a subset of the endpoints (e.g., user 141 may identify endpoints for which user 141 desires captions). When captions for audio from multiple endpoints are received, endpoint 101 may indicate on display 121 from which endpoint (or endpoint user if known) audio for certain captions was received.

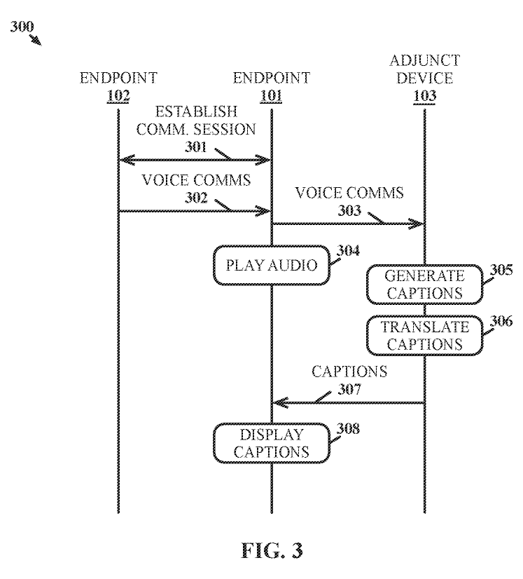

FIG. 3 illustrates operational scenario 300 for captioning a communication session on an endpoint using an adjunct device. In operational scenario 300, endpoint 101 and endpoint 102 establish a real-time communication session (step 301). The real-time communication session of this example includes at least voice communications from user 142 but may also be a video call having voice communications for captioning. The communication session may be established using circuit switched (e.g., PSTN) signaling or packet-based session initiation signaling, such as messages exchanged using Session Initiation Protocol (SIP).

Endpoint 101 receives voice communications from endpoint 102 over the established communication session (step 302). The voice communications may be one side of a conversation between user 141 and user 142. Voice communications from endpoint 101 to endpoint 102 for that conversation are not shown in operational scenario 300. Although, endpoint 102 may perform similar steps to use an adjunct device thereat to caption voice communications from endpoint 101. Endpoint 101 passes the voice communications to adjunct device 103 as the voice communications are received (i.e., in real time) to adjunct device 103 (step 303) and plays the voice communications as audio out of a speaker for endpoint 101 (step 304). Thus, in addition to presenting the voice communications to user 141 (e.g., via a handset, headset, speakerphone speaker, or other speaker connected to endpoint 101), as an endpoint commonly does, endpoint 101 is configured to send the voice communications to adjunct device 103 for captioning.

Since endpoint 101 immediately plays the audio, adjunct device 103 is configured to generate the captions as quickly as possible such that the caption for a word appears to be displayed as the word finishes being played by endpoint 101 (step 305). In some examples, adjunct device 103 may transmit the generated captions as is to endpoint 101 for display. In this example, adjunct device 103 translates the captions from one language to another (step 306). For instance, user 142 may be speaking Spanish in the voice communications. If user 141 does not understand Spanish (or would otherwise appreciate a translation thereof), then user 141 may request the captions be translated into English (or other desired language). User 141 may explicitly indicate to adjunct device 103 that translation is needed or desired, including which language is being received and to which language the received language should be translated. Alternatively, adjunct device 103 may automatically detect that translation is necessary.

The translated words are then provided to endpoint 101 as captions (step 307) where the captions are displayed on display 121 in real time as they are received (step 308). When not translating the captions, the words are transmitted from adjunct device 103 as soon as they are identified to ensure they are displayed as soon as possible relative to the words being played to user 141. In this example, since words are often reordered, removed, split up, etc. to comply with grammar differences between languages, adjunct device 103 may transmit the captions to endpoint 101 upon the grammar of the current phrase being finalized. Alternatively, adjunct device 103 may do a word-for-word translation and may update the captions to correct grammar.

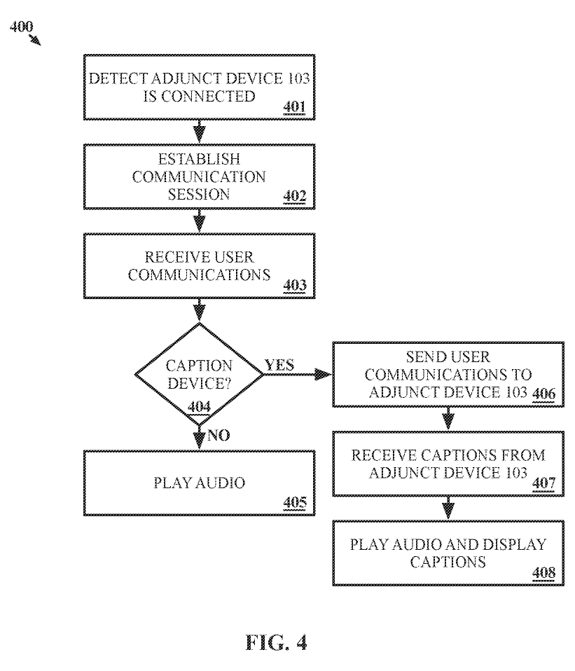

FIG. 4 illustrates operation 400 to caption a communication session on an endpoint using an adjunct device. In the example of operation 400, endpoint 101 is configured to detect when adjunct device 103 is connected thereto (step 401). This enables endpoint 101 to operate without captioning provided by adjunct device 103 when adjunct device 103 is not connected. For example, endpoint 101 may be a desktop telephone that did not include captioning functionality when produced by its manufacturer. Endpoint 101 may then receive a software with instructions for sending audio to an adjunct device when an adjunct device is connected. When an adjunct device is not connected to endpoint 101, endpoint 101 may operate as it did prior to receiving the software update. Endpoint 101 may detect adjunct device 103 using any detection mechanism provided by the connection interface between endpoint 101 and adjunct device 103. For example, the USB standard includes protocols for hot swapping peripherals. If adjunct device 103 is connected to endpoint 101 via USB, then endpoint 101 will detect adjunct device 103 like it would any other USB device.

Endpoint 101 establishes a communication session with endpoint 102 (step 402) and begins receiving user communications from endpoint 102 over that communication session (step 403). Although adjunct device 103 is connected prior to the establishment of the communication session in this example, adjunct device 103 may be connected after the communication session is established in other examples. For instance, after hearing how user 142 sounds coming from endpoint 101, user 141 may determine that captions would be helpful and connect adjunct device 103 at that time.

Endpoint 101 determines whether adjunct device 103 is a device capable of providing captions to endpoint 101 for display (step 404). This determination may also be made when adjunct device 103 is first attached to endpoint 101 (e.g., at step 401). If adjunct device 103 was not a captioning device, then endpoint 101 would play the audio received from endpoint 102 (step 405). Playback of the audio may be played in the condition it was received or may be subject to additional processing by endpoint 101 (e.g., endpoint 101 may perform noise reduction on the audio).

Since adjunct device 103 is a device for captioning audio, endpoint 101 sends the user communications to adjunct device 103 (step 406) and receives the generated captions from adjunct device 103 (step 407). Endpoint 101 plays the audio, like it did in step 405, and displays the received captions (step 408). Steps 406-408 occur continually in real time as communications are received over the communication session. As words are spoken by user 142, those words are transmitted to endpoint 101 where they are played to user 141 and captions of the words are displayed contemporaneously therewith. That is, the captions are displayed at about the same time (minus a relatively negligible amount of time for latency from adjunct device 103) as the words are played. As such, if user 141 is hard of hearing, user 141 can still participate in the real time conversation with user 142 by reading the captions generated by adjunct device 103.

In some examples, other types of devices may be connected to endpoint 101 like adjunct device 103 (e.g., via USB, Bluetooth, or LAN). At step 401, endpoint 101 may detect another type of device but at step 404 endpoint 101 may recognize the device is not a caption device. Although, in some situations, the device may identify itself to endpoint 101 as being a caption device even though the device does not provide captions to endpoint 101 like adjunct device 103 does in operation 400. For instance, the device may be connected to endpoint 101 by an individual intending to snoop on user 141's private conversations. By misidentifying itself to endpoint 101, endpoint 101 may determine at step 404 to send audio to the device just like it would to adjunct device 103. However, to protect against such snooping, endpoint 101 may be configured to stop sending audio upon recognizing that endpoint 101 is not receiving captions in return from the device. Preventing multiple users from simultaneously being logged into endpoint 101 is also important to ensure other users cannot likewise enable the snooping.

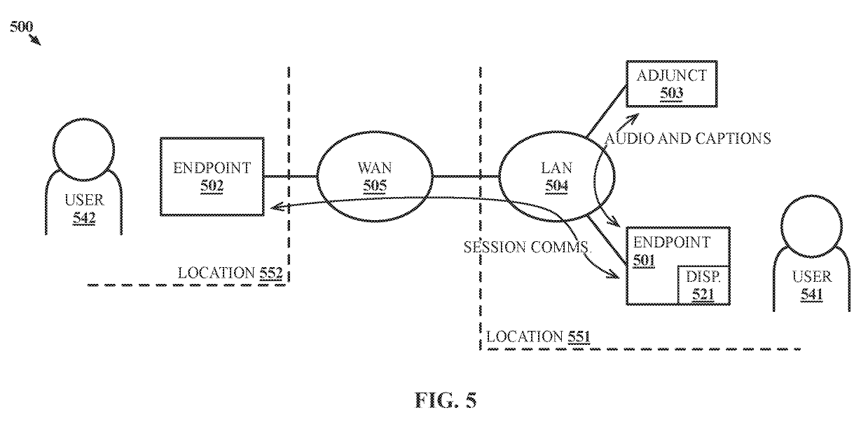

FIG. 5 illustrates implementation 500 for an adjunct device to caption a communication session on an endpoint. Implementation 500 includes endpoint 501, endpoint 502, adjunct device 503, LAN 504, and Wide Area Network (WAN) 505. User 541 operates endpoint 501 and user 542 operates endpoint 502. LAN 504 connects computing systems, including endpoint 501 and adjunct device 503, at location 551. WAN 505 connects LAN 504 at location 551 to endpoint 502 at location 552. Location 552 may also include a LAN connecting endpoint 502 to WAN 505. Location 551 and location 552 may be different geographic locations any amount of distance apart. WAN 505 may include the Internet. LAN 504 and endpoint 502 may connect to WAN 505 via an Internet Service Provider (ISP).

In operation, implementation 500 is an example of implementation 100 where endpoint 101 connects to adjunct device 103 using LAN 504 rather than some other connection method (e.g., USB, Bluetooth, etc.). For instance, endpoint 501 and adjunct device 503 may both be positioned on a desk of user 541 and are both connected to LAN 504. User 541 is, therefore, in physical control of both devices. Endpoint 501 may be connected to LAN 504 to join communication sessions with other endpoints and adjunct device 503 may likewise be connected to LAN 504 for purposes other than communicating with endpoint 501. The use of LAN 504 for the local connection between endpoint 501 and adjunct device 503 in those cases may be the most convenient connection method. For example, endpoint 501 may be a desktop telephone operated by user 541 and adjunct device 503 may be a desktop computer of user 541 (e.g., executing a software application to function as an adjunct device described herein). Even though adjunct device 503 may itself have a display in this example, adjunct device 503 still operates to provide captions for presentation on display 521 of endpoint 501. In other examples, adjunct device 503 may be connected to LAN 504 explicitly for the purpose of captioning communications from endpoint 501. Likewise, it is also possible for endpoint 501 to be connected to LAN 504 for communicating with adjunct device 503 while communicating with other endpoints over a network different from LAN 504.

As shown in implementation 500, endpoint 501 and endpoint 502 exchange user communications over a communications session established therebetween. In some examples, endpoint 502 may be on LAN 504 without reaching WAN 505. For instance, location 551 may serve an office building with endpoint 502 being in the same building. In further examples where more than two endpoints are on the communication session, a portion of the endpoints may be connected via LAN 504 while another portion is connected over WAN 505. In the present example, upon receiving communications from endpoint 502, endpoint 501 passes the communications to adjunct device 503 over LAN 504 and receives captions generated by adjunct device 503 over LAN 504. This process is like the other examples presented herein with LAN 504 providing the local connection.

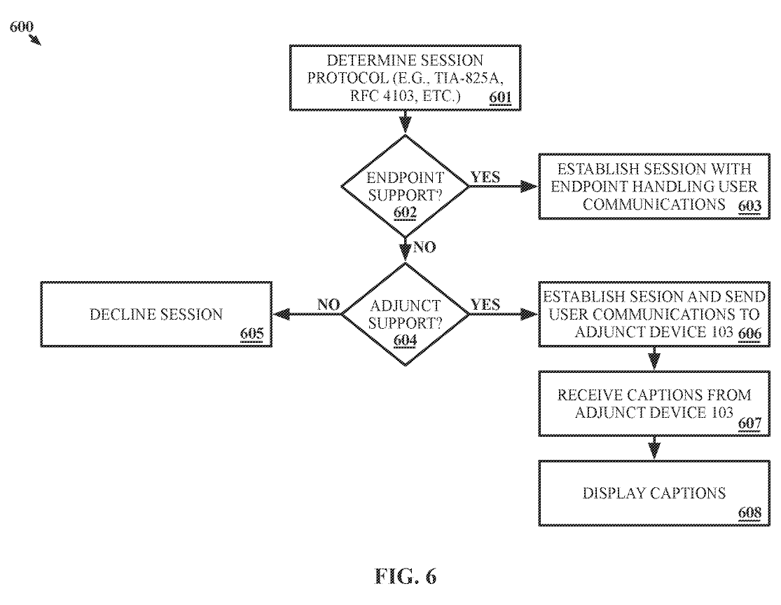

FIG. 6 illustrates operation 600 to caption a communication session on an endpoint using an adjunct device. Operation 600 is an example where the user communications captioned by adjunct device 103 are received in a format other than audio including user 142's voice. In this example, endpoint 101 determines a protocol being used to exchange user communications over the communication session (step 601). The protocol may be determined during an initial handshake to setup a communication session (e.g., endpoint 102 may indicate to endpoint 101 a protocol endpoint 102 will be using to exchange user communications). Two example protocols are TIA-825A and RFC 4103, although other protocols may be used for communication signaling including the speech in audio as described above. The TIA-825A protocol, established by the Telecommunications Industry Association, is a standard that enables text communication over analog telephone lines. It is designed to support users with hearing and speech disabilities by allowing the transmission of text in real-time, ensuring that these users can engage in telephone conversations. This protocol is particularly essential for devices such as teletypewriters (TTYs), which require a reliable method to transmit text over traditional phone networks. Similarly, RFC 4103 is a protocol that enables real-time text communication over IP networks, specifically designed to support users with hearing and speech disabilities. RFC 4103 facilitates the transmission of text characters instantly as they are typed, ensuring that conversations can flow seamlessly and naturally in real-time, just like spoken dialogue.

Once the protocol is determined, endpoint 101 determines whether endpoint 101 supports the protocol (step 602). Endpoint 101 will know which protocols it supports so the determination may simply be a determination about whether the determined protocol matches a supported protocol. If the protocol is supported by endpoint 101, then endpoint 101 establishes the communication session using the protocol and handles those communications without passing them to adjunct device 103 (step 603). If endpoint 101 does not support the protocol, endpoint 101 determines whether adjunct device 103 supports the protocol (step 604). Endpoint 101 may maintain a listing of protocols supported by adjunct device 103 (e.g., either preprogrammed into endpoint 101 or provided to endpoint 101 after connecting adjunct device 103 thereto) or endpoint 101 may query adjunct device 103 over the local connection to ask adjunct device 103 whether the protocol is supported. If the protocol is also not supported by adjunct device 103, then endpoint 101 declines the session (step 605). If the session is an IP session, then endpoint 101 declines endpoint 102’s request to establish the session. If the session is an analog call (e.g., using TIA-825A), endpoint 101 may disconnect from the call (e.g., hang up on the call). In other examples, endpoint 101 may allow the session to continue while relying on user 141 or user 142 to recognize that the protocol is not supported.

In contrast, if endpoint 101 determines adjunct device 103 supports the protocol, then endpoint 101 establishes the session and sends the user communications in the protocol to adjunct device 103 (step 606). For instance, while a session handshake for a packet-based session (e.g., a session using RFC 4103) may fail when endpoint 101 declines the session at step 605, the handshake succeeds in step 606 upon determining adjunct device 103 supports the packet-based protocol. In some cases, after establishing a text-based session (e.g., a session using RFC 4103 or TIA-825A), endpoint 101 may transmit a message over the session to inform user 142 that text communications can be received but not transmitted, as endpoint 101 may not be equipped with a keyboard for typing messages. Adjunct device 103 generates captions 131 from the user communications. In this example, since the user communications are already in a text format, adjunct device 103 reformats the text communications into a format that endpoint 101 can display on display 121. Endpoint 101 receives captions 131 from adjunct device 103 (step 607) and displays captions 131 on display 121 (step 608). Protocols like RFC 4103 enable individual characters to be sent in real time as user 142 types them (e.g., rather than waiting for user 142 to press send upon completing a text string). In such cases, adjunct device 103 will likewise add those characters to captions 131 as they are received to display on display 121 immediately rather than waiting for a complete word or phrase to be received.

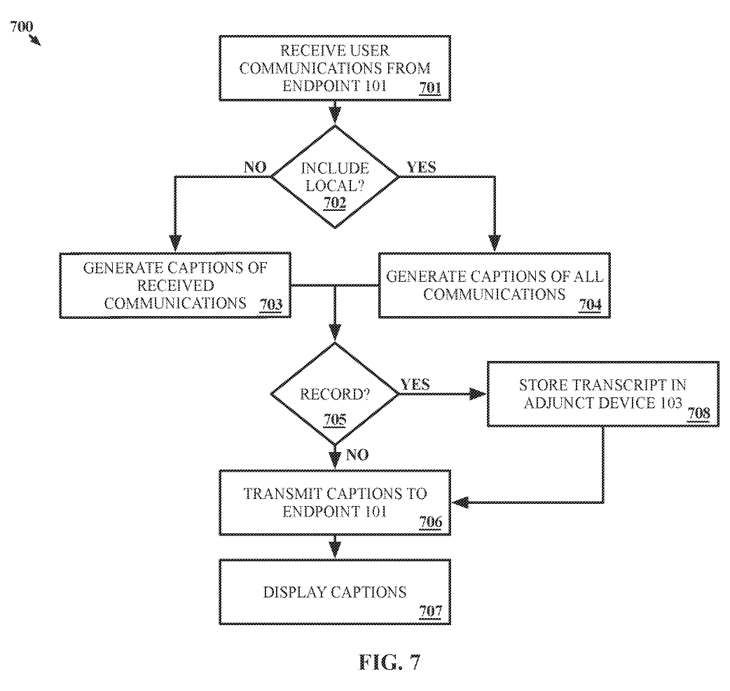

FIG. 7 illustrates operation 700 to caption a communication session on an endpoint using an adjunct device. In operation 700, adjunct device 103 is configured to store transcripts of the generated captions allowing user 141 to access the captions later. Adjunct device 103 receives user communications from endpoint 101 (step 701). As in the examples above, the user communications at least include communications from endpoint 102 but may include communications from other endpoints that may also be on the communication session. Adjunct device 103 determines whether local communications captured by endpoint 101 (e.g., communications spoken by, or otherwise received from, user 141) should be included in captions 131 and/or a transcript thereof) (step 702). For example, adjunct device 103 may include a user interface (e.g., switch, button, graphic toggle, etc.) user 141 can use to indicate whether they want local communications to be included. In some examples, a user interface on endpoint 101 (e.g., using display 121) may enable user 141 to indicate such preferences to adjunct device 103 via endpoint 101.

If local communications are not to be included, adjunct device 103 generates captions of only received communications (step 703). In some examples, adjunct device 103 may receive local communications as well but omits those local communications from inclusion in the captions. In other examples, adjunct device 103 may instruct endpoint 101 as to which communications should be passed to adjunct device 103 such that adjunct device 103 can caption whatever communications are received. This may also enable adjunct device 103 to direct endpoint 101 to only send communications from a portion of the endpoints on a communication session if more than just endpoint 101 and endpoint 102 are connected to the session. If local communications are to be included, adjunct device 103 generates captions of both received communications and the local communications, which is all communications in this example of a session between endpoint 101 and endpoint 102 (step 704).

Adjunct device 103 further determines whether the captions should be recorded as a transcript (step 705). Transcript recording may be on by default or user 141 may indicate their desire for transcripts to be recorded via an interface like that described above for indicating whether local communications should be included in the captions. If a transcript should not be stored, adjunct device 103 transmits the captions as they are generated in real time to endpoint 101 (step 706), which displays the received captions on display 121 in real time as they are received (step 707). If a transcript should be stored, adjunct device 103 stores the captions as a transcript in a memory (e.g., flash memory) of adjunct device 103 (step 708) in addition to transmitting the captions to endpoint 101 at step 706. The transcript may be stored in a text file that can be accessed from adjunct device 103, endpoint 101 when adjunct device 103 is connected, or from some other computing system to which adjunct device 103 is connected or to which the file is copied. The transcript may be available for access prior to the communication session ending (e.g., to allow user 141 to look back at what was said previously during the conversation) or adjunct device 103 may wait until the communication session has concluded to finalize the transcript for access. The transcript may also be timestamped (e.g., with a time of day or a time since the session began) to enable synchronization with a recording of the audio. As such, the transcript may be used to caption a playback of the recording.

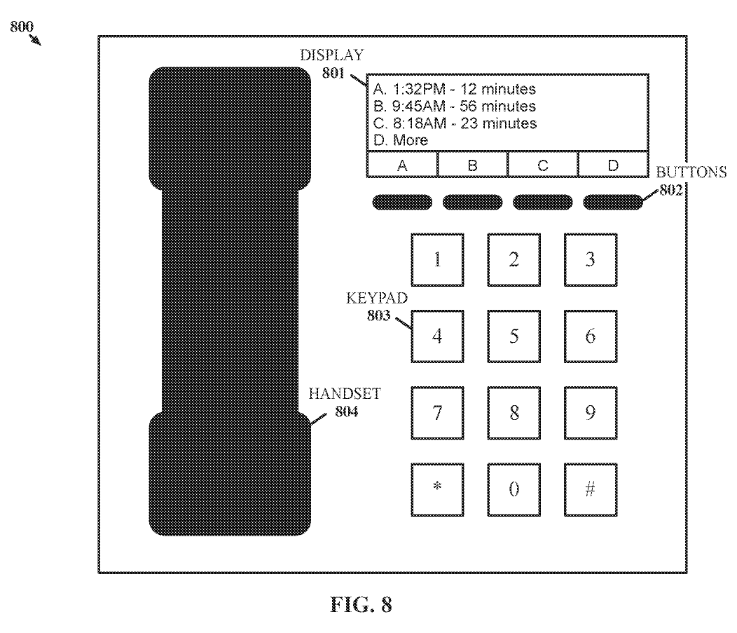

FIG. 8 illustrates endpoint device 800 to caption a communication session thereon using an adjunct device. Endpoint device 800 includes display 801, buttons 802, keypad 803, and handset 804. Endpoint device 800 is an example of endpoint 101 if endpoint 101 is a desktop telephone. User 141 can pick up handset 804, which includes a speaker and microphone, to answer incoming voice calls or use keypad 803 to dial outgoing voice calls. Display 801 is an example of display 121 capable of displaying characters. Buttons 802 are used by user 141 to interact with a Graphical User Interface (GUI) presented on display 801. Keypad 803 may also be used for such interactions in other examples. Endpoint device 800 and its components are merely an example of a desktop telephone. Other form factors and user interface elements may be used in other examples.

In this example, display 801 is displaying an interface into transcripts stored on adjunct device 103. Display 801 would display captions received from adjunct device 103, such as captions 131, if endpoint device 800 was connected to a communication session. The transcripts interface in this case lists transcripts available on adjunct device 103 with the transcripts being identified to user 141 with their start time and length. Other information, such as a calling number, caller ID, or other descriptive information may be used to identify the transcripts in other examples. The GUI of this example enables user 141 to select one of buttons 802 corresponding to a letter of a desired selection. For instance, if user 141 wishes to view the transcript of the letter “A,” then user 141 will select the left most button of buttons 802, which corresponds to “A” on display 801. Again, other types of GUIs may be used in other examples. Upon selecting a transcript, the selection is passed to adjunct device 103, which supplies the transcript to endpoint device 800 for presentation on display 801. Given the limited number of lines available to display text on display 801, user 141 may use buttons 802 or keypad 803 to scroll through the transcript.

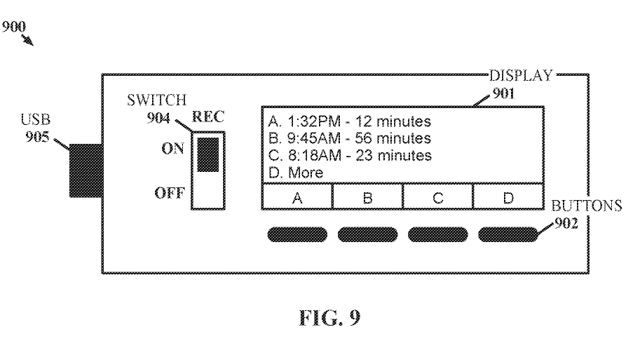

FIG. 9 illustrates adjunct device 900 to generate captions for a communication session on an endpoint. Adjunct device 900 includes display 901, buttons 902, recording switch 904, and USB connector 905. Adjunct device 900 is an example of adjunct device 103. Display 901 is not meant to display captions because the captions generated by adjunct device 900 are intended to be displayed on endpoint 101. As such, in some examples, adjunct device 103 will not have a display at all and, if a transcript interface is supplied, the transcript interface will use another device, such as endpoint device 800, for the display. Display 901 in this case is displaying an interface into transcripts stored on adjunct device 900. The interface is like the interface shown on display 801 of endpoint device 800 with user 141 being able to use buttons 902 for selecting a desired transcript. Adjunct device 900 will retrieve a selected transcript from memory and display the transcript on display 901.

User 141 may further use recording switch 904 to indicate user 141's desire for transcripts of captions to be stored. Other types of interface elements may also be used to indicate a recording preference, such as a GUI interface displayed on display 901 and selected via buttons 902. Likewise, a similar switch or interface element may exist on adjunct device 900 allowing the user to indicate whether local communications for the communication session should also be captioned and/or stored in the transcript. User 141's recording preferences may also be indicated via an interface presented at endpoint 101 in some examples.

In this example, USB connector 905 is used to connect adjunct device 900 to endpoint 101. For instance, using endpoint device 800 as an example, endpoint device 800 may include a USB port on one side into which USB connector 905 can be inserted. The local connection for exchanging user communications and captions would, therefore, be over the USB interface. Adjunct device 900 may be powered via USB connector 905 from endpoint 101, may use battery power, may connect to AC power, or may receive power from some other source. USB connector 905 may be the only way adjunct device 900 can be connected to an endpoint or adjunct device 900 may include other interfaces, such as Bluetooth.

The example form factor for adjunct device 900 is meant to be relatively small (e.g., smaller enough to fit on user 141's pocket). As such, if endpoint 101 is not the only endpoint 101 may use (e.g., user 141 works for a company that rotates offices/desks), user 141 can bring adjunct device 900 along to plug into any endpoint configured to communicate with adjunct device 900 to provide that endpoint with the captioning capabilities described herein.

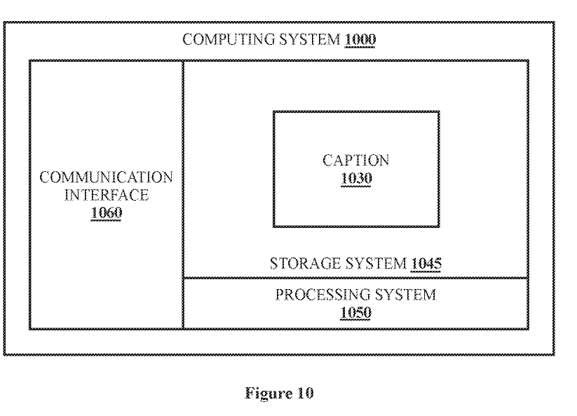

FIG. 10 illustrates computing system 1000 for captioning a communication session on an endpoint using an adjunct device. Computing system 1000 is representative of any computing system or systems with which the various operational architectures, processes, scenarios, and sequences disclosed herein can be implemented. Computing system 1000 is an example architecture for adjunct device 103 and adjunct device 503, although other examples may exist. Computing system 1000 includes storage system 1045, processing system 1050, and communication interface 1060. Processing system 1050 is operatively linked to communication interface 1060 and storage system 1045. Communication interface 1060 may be communicatively linked to storage system 1045 in some implementations. Computing system 1000 may further include other components such as a battery and enclosure that are not shown for clarity.

Communication interface 1060 comprises components that communicate over communication links, such as network cards, ports, radio frequency (RF), processing circuitry and software, or some other communication devices. Communication interface 1060 may be configured to communicate over metallic, wireless, or optical links. Communication interface 1060 may be configured to use Time Division Multiplex (TDM), Internet Protocol (IP), Ethernet, optical networking, wireless protocols, communication signaling, or some other communication format — including combinations thereof. Communication interface 1060 may be configured to communicate with one or more web servers and other computing systems via one or more networks.

Processing system 1050 comprises microprocessor and other circuitry that retrieves and executes operating software from storage system 1045. Storage system 1045 may include volatile and nonvolatile, removable, and non-removable media implemented in any method or technology for storage of information, such as computer readable instructions, data structures, program modules, or other data. Storage system 1045 may be implemented as a single storage device but may also be implemented across multiple storage devices or sub-systems. Storage system 1045 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 1045, or any other computer-readable storage medium herein, be considered a transitory form of signal transmission (often referred to as "signals per se"), such as a propagating electrical or electromagnetic signal or carrier wave.

Processing system 1050 is typically mounted on a circuit board that may also hold the storage system. The operating software of storage system 1045 comprises computer programs, firmware, or some other form of machine-readable program instructions. The operating software of storage system 1045 comprises caption module 1030. The operating software on storage system 1045 may further include an operating system, utilities, drivers, network interfaces, applications, or some other type of software. When read and executed by processing system 1050, the operating software on storage system 1045 directs computing system 1000 to caption user communications received from an endpoint over a local connection to communication interface 1060.

In at least one example, caption module 1030 directs processing system 1050 to receive, over the local connection, communication signaling in real time from a first endpoint of the communication session. The first endpoint received the communication signaling from a second endpoint over the communication session. Caption module 1030 directs processing system 1050 to perform real-time processing on the communication signaling to generate captions of words identified in the communication signaling and transmit the captions in real time to the first endpoint over the local connection. The first endpoint presents the captions to a user of the first endpoint in real time.

In another example, computing system 1000 may be an example of endpoint 101. The operating software in that case may direct processing system 1050 to receive user communications over a communication session from another endpoint on the communication session and transmit the user communications in real time to an adjunct device via a channel separate from the communication session. The operating software may further direct processing system 1050 to receive, from the adjunct device via the channel, real time captions generated by the adjunct device from the user communications and display the real time captions in real time on the display.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for captioning a communication session on an endpoint display, the method comprising:
receiving, at a first endpoint of the communication session, audio from a second endpoint of the communication session;
passing the audio in real time to an adjunct device of the first endpoint over a local connection;
performing, in the adjunct device, real-time speech-to-text processing on the audio to generate captions of speech identified in the audio;
transmitting the captions in real time to the first endpoint over the local connection; and
displaying the captions in real-time on a display of the first endpoint.

2. The method of claim 1, comprising:
playing the audio through a speaker of the first endpoint at contemporaneously with displaying the captions.

3. The method of claim 1, comprising:
in the first endpoint, determining a user has connected the adjunct device, wherein the audio is passed in response to determining the user had connected the adjunct device.

4. The method of claim 1, comprising:
in the adjunct device, translating the captions from a first language to a second language prior to transmission to the first endpoint.

5. The method of claim 1, wherein the local connection comprises one of:
a Universal Serial Bus (USB) connection;
a Bluetooth connection; and
a Local Area Network (LAN) connection.

6. The method of claim 1, comprising:
storing a transcript of the captions in the adjunct device for future access.

7. The method of claim 6, comprising:
in the first endpoint, displaying an interface for transcripts stored on the adjunct device after the communication session ends;
receiving input from a user selecting the transcript via the interface;
in response to the input, transmitting the transcript from the adjunct device to the first endpoint; and
displaying the transcript in the interface.

8. The method of claim 1, comprising:
capturing local audio from a user of the first endpoint;
passing the local audio to the adjunct device in real time; and
performing, in the adjunct device, the real-time speech-to-text processing on the local audio to include, in the captions, local speech identified in the local audio.

9. The method of claim 8, comprising:
receiving input from the user indicating the local speech should be included in the captions.

10. The method of claim 1, comprising:
continuing to display the captions even when audio output from the first endpoint is disabled.

11. An apparatus for captioning a communication session on an endpoint display, the apparatus comprising:
one or more computer readable storage media;
a processing system operatively coupled with the one or more computer readable storage media; and
program instructions stored on the one or more computer readable storage media that, when read and executed by the processing system, direct the apparatus to:
receive, over a local connection, communication signaling in real time from a first endpoint of the communication session, wherein the first endpoint received the communication signaling from a second endpoint over the communication session;
perform real-time processing on the communication signaling to generate captions of words identified in the communication signaling; and
transmit the captions in real time to the first endpoint over the local connection, wherein the first endpoint presents the captions to a user of the first endpoint in real time.

12. The apparatus of claim 11, wherein the communication signaling carries user communications of one type in a group of types comprising:
audio capturing speech of a second user at the second endpoint;
text in accordance with a TIA-825A standard; and
text in an RFC 4103 standard.

13. The apparatus of claim 11, comprising one or more interfaces for the local connection from a group of interfaces including:
a Universal Serial Bus (USB) interface;
a Local Area Network (LAN) interface; and
a Bluetooth interface.

14. The apparatus of claim 11, wherein the program instructions direct the apparatus to:
store a transcript of the captions in a local repository with other transcripts, wherein the local repository is in the one or more computer readable storage media.

15. The apparatus of claim 14, comprising:
a display,
wherein the program instructions direct the apparatus to display a user interface enabling the user to select the transcript from the other transcripts for presentation after the communication session ends.

16. The apparatus of claim 11, wherein the program instructions direct the apparatus to:
determine the captions are in a different language than a desired language of the user; and
translating the captions to the desired language prior to transmission of the captions to the first endpoint.

17. An apparatus for captioning a communication session on an endpoint display, the apparatus comprising:
a display;
one or more computer readable storage media;
a processing system operatively coupled with the one or more computer readable storage media; and
program instructions stored on the one or more computer readable storage media that, when read and executed by the processing system, direct the apparatus to:
receive user communications over the communication session from an endpoint on the communication session;
transmit the user communications in real time to an adjunct device via a channel separate from the communication session;
receive, from the adjunct device via the channel, real time captions generated by the adjunct device from the user communications; and
display the real time captions in real time on the display.

18. The apparatus of claim 17, comprising:
a speaker, and
wherein the user communications include audio of a user captured by the endpoint;
wherein the program instructions direct the processing system to play the audio via the speaker in real time.

19. The apparatus of claim 17, wherein the program instructions direct the apparatus to:
display a user interface for the adjunct device on the display.

20. The apparatus of claim 19, wherein the program instructions direct the apparatus to:
receive input from a user to the user interface; and
transmit the input to the adjunct device over the channel.
